(19) United States
(12) Patent Application Publication
(10) Pub. No.: US 2008/0243557 A1
(43) Pub. Date: Oct. 2, 2008

(54) Information transmission system

(76) Inventors: Toshihiro Ohara, Fukuoka-shi (JP); Tomokazu Sugimoto, Kitakyusyu-shi (JP)

Correspondence Address: JORDAN AND HAMBURG LLP, 122 EAST 42ND STREET, SUITE 4000, NEW YORK, NY, 10168, US

(21) Appl. No.: 12/077,168

(22) Filed: Mar. 17, 2008

(30) Foreign Application Priority Data
Mar. 27, 2007 (JP) 2007-81946

(51) Int. Cl. G06Q 40/00

(52) U.S. Cl. 705/4

(57) ABSTRACT

An information transmission system is composed of a policyholder terminal used by the policyholder and an insurer server used by an insurer, the policyholder terminal includes: a policyholder information transmitting step for transmitting information regarding the policyholder to the insurer server via the Internet; an information receiver information transmitting step for transmitting information regarding an information receiver to the insurer server; and a transmission information depositing step for depositing transmission information with the insurer server, and the insurer server includes: a policyholder information recording step for recording the information regarding the policyholder; an information receiver information recording step for recording the information regarding the information receiver; a transmission information storing step for storing information to be transmitted to the information receiver; and a transmission information transmitting step for transmitting the information to the information receiver in the case where a predetermined condition is satisfied.

### BACKGROUND OF THE INVENTION

(1) Field of the Invention

The present invention relates to an information transmission system, more particularly, it relates to an information transmission system for notification of an insurance contract.

(2) Description of Related Art

Currently, many kinds of guarantee products such as mutual-aid products and insurance products are offered, and not only a limited term life but also whole life is guaranteed against death and disease. There exists an insurance product in which an insurance premium is required to be paid only in a term specified in an insurance contract, or during the whole term of the contract. Additionally, there exists an insurance product in which an insurance premium is fixed, or an owner of an insurance policy can decide, under a specific guidelines, the level of an insurance premium to be paid. Further, there exists an insurance product in which it is agreed to pay a benefit specified in an insurance policy in a lump-sum payment, or pay it in installments for a specified number of times.

In terms of benefits, life insurance has been classified into three classes: term life insurance, endowment insurance and whole life insurance, as well as a combination of two or more of these.

With term life insurance, a predetermined benefit is paid to a beneficiary in the case where the insured dies at a certain point within defined years (insurance contract term) shorter than his life. With endowment insurance, similar to term insurance, a predetermined benefit is paid to a beneficiary in the case where the insured dies at a certain point during a contract term, or a benefit is paid to a policyholder in the case where the insured survives the contract term. With whole life insurance, a predetermined benefit is paid to a beneficiary when the insured dies regardless of the date of death. Additionally, although a cancellation refund is not paid with the term life insurance, it is paid with the endowment insurance and whole life insurance.

Additionally, there exist various types of term life insurance and whole life insurance. For example, as whole life insurance, “normal life insurance” is cited that an insurance premium should be paid throughout the whole life. Additionally, there exists “limited term payment whole life insurance” that, although a face value of an insurance policy should be paid at death, an insurance premium is charged and paid for a limited number of years and then the total face value of the insurance policy is considered to be completely paid.

However, with life insurance, it is not easy to, after the fact, revise the contents of the guarantee defined at the time of contracting and an insurance premium to be paid decided based on the contents of the guarantee. Additionally, even if a new life insurance contract is concluded by conversion and thereby the contents and insurance premium are revised, the insurance premium to be paid is increased in proportion to an increase in the guarantee and the economic burden thereby is also increased.

Additionally, although whole life insurance and endowment insurance have a high savings function in the insurance products, a part or the whole of the insurance contract is required to be cancelled in order to pull out equity by use of the savings function, and thus the guarantee is lost.

Thereupon, a system shown in FIG. 3 is proposed as an insurance system capable of revising, in accordance with a life cycle, the contents of the guarantee and the insurance premium to be paid, and of increasing the guarantee and reducing the insurance premium. FIG. 3 is a schematic diagram illustrating a conventional insurance system, and JP2001-344422(A) discloses an insurance system including: a reserve totaling part 101 for reserving an insurance premium to be paid in a period of payment of the premium, and insurance money, benefit, dividend and temporary investment money of another insurance contract; an insurance premium paying part 102 for paying a special insurance premium and an insurance premium of another insurance contract from a reserve of the reserve totaling part 101; a guarantee adjusting part 103 capable of revising and adjusting the contents of a special insurance contract; a reserve withdrawing part 104 capable of withdrawing a part of the reserve of the reserve totaling part 101 within a predetermined period; and an expiration time fund managing part 105 for using the reserve of the reserve totaling part 101 as a fund of the succeeding insurance upon expiration of a period of paying the insurance premium.

### BRIEF SUMMARY OF THE INVENTION

On the other hand, in a conventional insurance system, insurance money is simply transferred regarding payment of the insurance money, and the wishes of a policyholder are not communicated to a bereaved family and the like.

The present invention was made in view of the above problem, and it is an object of the present invention to provide an information transmission system for communicating the wishes of the policyholder to persons related to the policyholder as a message.

In order to achieve the above problem, in an information transmission system of the present invention, information is transmitted by a policyholder terminal used by a policyholder and an insurer server used by an insurer, the policyholder terminal including: policyholder information transmitting means for transmitting information regarding the policyholder to the insurer server; information receiver information transmitting means for transmitting information regarding an information receiver, which receives information transmitted from the policyholder in the case where a predetermined condition is satisfied, to the insurer server; and transmission information depositing means for depositing information to be transmitted to the information receiver with the insurer server, and the insurer server including: policyholder information recording means for recording the information regarding the policyholder transmitted by the policyholder information transmitting means; information receiver information recording means for the information regarding the information receiver transmitted by the information receiver information transmitting means; transmission information storing means for storing the information to be transmitted to the information receiver, the information being deposited by the transmission information depositing means; and transmission information transmitting means for transmitting, in the case where a predetermined condition is satisfied, the information to be transmitted to the information receiver to the information receiver recorded in the information receiver information recording means, the information being stored by the transmission information storing means.

Here, the information to be transmitted to the information receiver stored by the transmission information storing means can be transmitted to the information receiver recorded in the information receiver information recording means, at a desired timing by the transmission information transmitting means for transmitting the information in the case where the predetermined condition is satisfied. Moreover, “predetermined condition” described herein is a condition decided beforehand by the policyholder or insurer.

Additionally, in order to achieve the above object, in an information transmission system of the present invention, information is transmitted by a policyholder terminal used by a policyholder, an insurer server used by an insurer and a transmission information storing server used by a transmission information managing company, the policyholder terminal including: policyholder information transmitting means for transmitting information regarding the policyholder to the insurer server; information receiver information transmitting means for transmitting information regarding an information receiver, which receives information transmitted from the policyholder in the case where a predetermined condition is satisfied, to the insurer server; and transmission information depositing means for depositing information to be transmitted to the information receiver with the insurer server, the insurer server including: policyholder information transferring means for transferring the information regarding the policyholder to the transmission information storing server, the information being transmitted by the policyholder information transmitting means; information receiver information transferring means for transferring the information regarding the information receiver to the transmission information storing server, the information being transmitted by the information receiver information transmitting means; and transmission information transferring means for transferring the information to be transmitted to the information receiver to the transmission information storing server, the information being deposited by the transmission information depositing means, and the transmission information storing server including: policyholder information recording means for recording the information regarding the policyholder transferred by the policyholder information transferring means; information receiver information recording means for recording the information regarding the information receiver transferred by the information receiver information transferring means; transmission information storing means for storing the information to be transmitted to the information receiver, the information being transferred by the transmission information transferring means; and transmission information transmitting means for transmitting, in the case where a predetermined condition is satisfied, the information to be transmitted to the information receiver to the information receiver recorded in the information receiver information recording means, the information being stored by the transmission information storing means.

Here, the insurer server used by the insurer and the transmission information storing server used by the transmission information managing company are provided, the information regarding the policyholder, information regarding the information receiver and transmission information are recorded and stored in the transmission information storing server, and thus many employees of the insurer can be prevented from accessing and extracting personal information of the policyholder depositing the transmission information, and extraction of the information can be prevented due to an employee's mental distance as a company other than the insurer manages the information.

Additionally, the information to be transmitted to the information receiver stored by the transmission information storing means can be transmitted to the information receiver recorded in the information receiver information recording means, at a desired timing by the transmission information transmitting means for transmitting the information in the case where the predetermined condition is satisfied. Moreover, “predetermined condition” described herein is a condition decided beforehand by the policyholder or insurer.

Additionally, in the information transmission system of the present invention, the policyholder terminal includes transmission information direct depositing means for direct depositing the information to be transmitted to the information receiver with the transmission information storing server, and, in the case where the transmission information storing means further stores the information to be transmitted to the information receiver, the information being directly deposited by the transmission information direct depositing means, the transmission information storing server can store the transmission information without passing through an insurer, and thus the possibility is further lowered that personal information is extracted.

Additionally, in order to achieve the above object, an information transmission system of the present invention has an insurer server used by an insurer and transmits information, the insurer server including: policyholder information receiving means for receiving information regarding a policyholder from a policyholder terminal used by the policyholder; information receiver information receiving means for receiving information regarding an information receiver, which receives information transmitted from the policyholder in the case where a predetermined condition is satisfied, from the policyholder terminal; transmission information accepting means for accepting information to be transmitted to the information receiver from the policyholder terminal; policyholder information recording means for recording the information regarding the policyholder received by the policyholder information receiving means; information receiver information recording means for recording the information regarding the information receiver received by the information receiver information receiving means; transmission information storing means for storing the information to be transmitted to the information receiver, the information being accepted by the transmission information accepting means; and transmission information transmitting means for transmitting, in the case where a predetermined condition is satisfied, the information to be transmitted to the information receiver to the information receiver recorded in the information receiver information recording means, the information being stored by the transmission information storing means.

Here, the information to be transmitted to the information receiver stored by the transmission information storing means can be transmitted to the information receiver recorded in the information receiver information recording means, at a desired timing by the transmission information transmitting means for transmitting the information in the case where the predetermined condition is satisfied. Moreover, “predetermined condition” described herein is a condition decided beforehand by the policyholder or insurer.

Additionally, in order to achieve the above object, an information transmission system of the present invention has an insurer server used by an insurer and a transmission information storing server used by a transmission information managing company, and transmits information, the insurer server including: policyholder information receiving means for receiving information regarding a policyholder from a policyholder terminal used by the policyholder; information receiver information receiving means for receiving information regarding an information receiver, which receives information transmitted from the policyholder in the case where a predetermined condition is satisfied, from the policyholder terminal; transmission information accepting means for accepting information to be transmitted to the information receiver from the policyholder terminal; policyholder information transferring means for transferring the information regarding the policyholder to the transmission information storing server, the information being received by the policyholder information receiving means; information receiver information transferring means for transferring the information regarding the information receiver to the transmission information storing server, the information being received by the information receiver information receiving means; and transmission information transferring means for transferring the information to be transmitted to the information receiver to the transmission information storing server, the information being accepted by the transmission information accepting means, and the transmission information storing server including: policyholder information recording means for recording the information regarding the policyholder transferred by the policyholder information transferring means; information receiver information recording means for recording the information regarding the information receiver transferred by the information receiver information transferring means; transmission information storing means for storing the information to be transmitted to the information receiver, the information being transferred by the transmission information transferring means; and transmission information transmitting means for transmitting, in the case where a predetermined condition is satisfied, the information to be transmitted to the information receiver to the information receiver recorded in the information receiver information recording means, the information being stored by the transmission information storing means.

Here, the insurer server used by the insurer and the transmission information storing server used by the transmission information managing company are provided, the information regarding the policyholder, information regarding the information receiver and transmission information are recorded and stored in the transmission information storing server, and thus many employees of the insurer can be prevented from accessing and extracting personal information of the policyholder depositing the transmission information, and extraction of the information can be prevented due to an employee's mental distance as a company other than the insurer manages the information.

Additionally, the information to be transmitted to the information receiver stored by the transmission information storing means can be transmitted to the information receiver recorded in the information receiver information recording means, at a desired timing by the transmission information transmitting means for transmitting the information in the case where the predetermined condition is satisfied. Moreover, “predetermined condition” described herein is a condition decided beforehand by the policyholder or insurer.

An information transmission system according to the present invention can communicate the wishes of a policyholder to persons related to the policyholder as a message.

### BRIEF DESCRIPTION OF THE DRAWINGS

FIG. 1 is a schematic diagram illustrating an information transmission system of a first embodiment of the present invention.

FIG. 2 is a schematic diagram illustrating an information transmission system of a second embodiment of the present invention.

FIG. 3 is a schematic diagram illustrating a conventional insurance system.

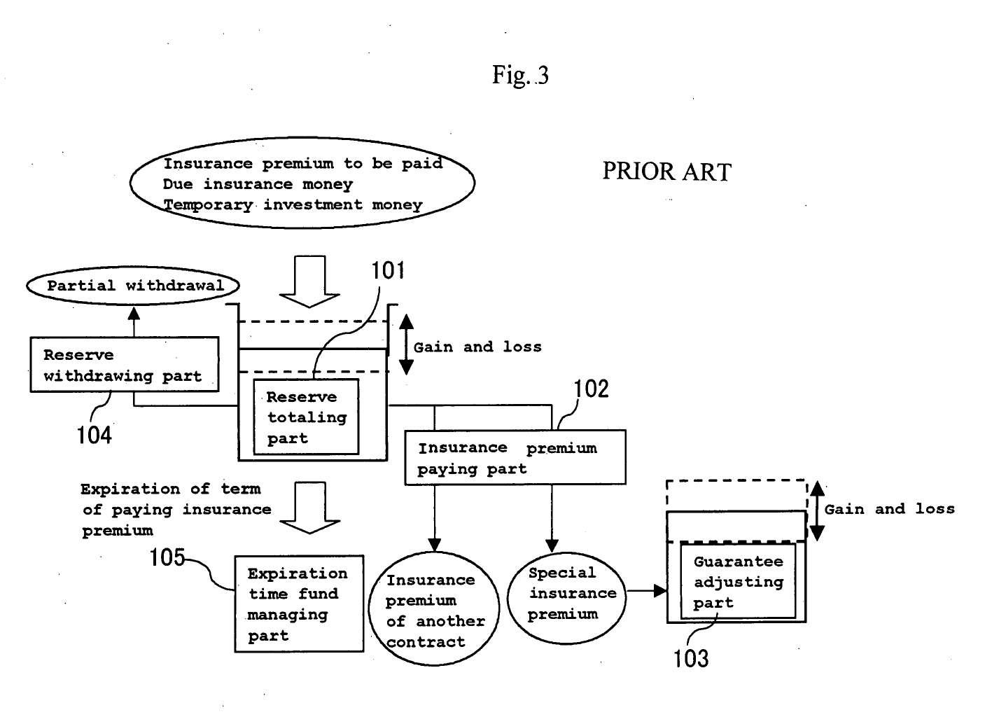

### DETAILED DESCRIPTION OF THE INVENTION

Embodiments of the present invention will be described below with reference to the drawings so that the present invention can be understood.

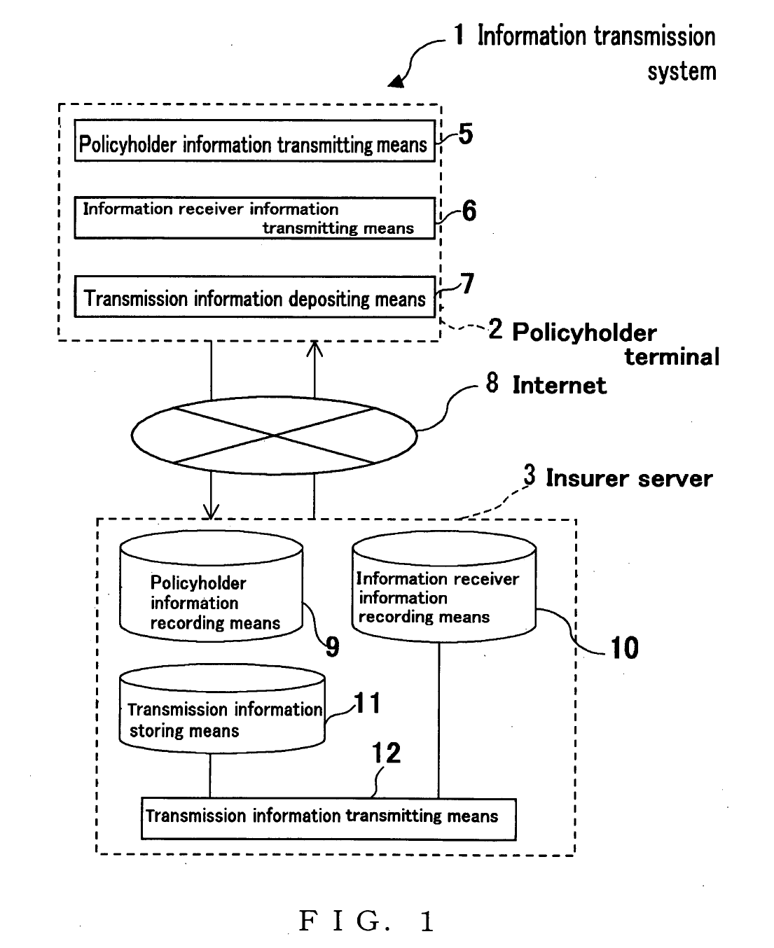

FIG. 1 is a schematic diagram illustrating an information transmission system of a first embodiment of the present invention. In FIG. 1, an information transmission system 1 of the present invention is composed of a policyholder terminal 2 used by a policyholder and an insurer server 3 used by an insurer.

Additionally, the policyholder terminal 2 includes: policyholder information transmitting means 5 for transmitting information regarding the policyholder, for example, address, name, age, birth-date, telephone number, contents of an insurance contract and e-mail address of the policyholder, to the insurer server 3 via the Internet 8; information receiver information transmitting means 6 for transmitting information regarding an information receiver, which receives information transmitted from the policyholder in the case where a predetermined condition is satisfied (for example, unconsciousness of the insured, death of the insured, passage of a specified term, e.g. 10, 20 or 30 years, from conclusion of an insurance contract), to the insurer server 3 via the Internet 8, the information regarding the information receiver being about, for example, address, name, telephone number, e-mail address of the information receiver; and transmission information depositing means 7 for depositing information to be transmitted to the information receiver with the insurer server 3 via the Internet 8. Moreover, the predetermined condition can be included in the contents of the insurance contract.

Additionally, the insurer server 3 includes: policyholder information recording means 9 for recording the information regarding the policyholder transmitted by the policyholder information transmitting means 5; information receiver information recording means 10 for recording the information regarding the information receiver transmitted by the information receiver information transmitting means 6; transmission information storing means 11 for storing the information to be transmitted to the information receiver, the information being deposited by the transmission information depositing means 7; and transmission information transmitting means 12 for transmitting, in the case where a predetermined condition is satisfied, the information to be transmitted to the information receiver to the information receiver recorded in the information receiver information recording means 10, the information being stored by the transmission information storing means 11.

Here the information regarding the policyholder, information regarding the information receiver and transmission information can be transmitted to or deposited with the insurer server, not only via the Interne t but also via, for example, mail, telephone, home parcel delivery and hand delivery.

Additionally, the “information receiver” consists of not only persons related to the policyholder, family, friend, acquaintance and the like, but also the policyholder himself.

Additionally, as a medium of the “transmission information,” for example, a letter addressed to the information receiver, and a record medium, in which a message for the information receiver is recorded, such as a videotape, CD or DVD are applicable.

Additionally, although an insurance contract is cited and explained as an example of a guarantee contact, a mutual-aid contract is, of course, applicable so long as it belongs to the guarantee contract.

Next, a letter will be cited as the medium of the transmission information, and a flow of storage of the transmission information will be described.

After conclusion of the insurance contract, the policyholder first hands a person in charge of the insurer a letter addressed to the information receiver, and requests him to store it. Next, the letter is scanned and converted into PDF data and the like to be stored as data, information is encrypted and entered onto an IC chip, the information related to: address, name, age, birth-date, telephone number and contents of the insurance contract of the policyholder recorded in the policyholder information recording means of the insurer server; a storage period of the letter; and address, name, telephone number and e-mail address of the information receiver (addressee) recorded by the information receiver information recording means of the insurer server, the information receiver being an addressee of the letter, the IC chip is attached to a letter storing envelope, the original of the letter is inserted into the letter storing envelope, to which the IC chip is attached, and the envelope is sealed. Then, when the sealed letter storing envelope, in which the original of the letter is enclosed, with the IC chip is placed in a warehouse, the information in the IC chip is read by an IC chip reading sensor set up at an entrance of the warehouse.

Thus, storing place and retrieval deadline can be managed. Additionally, since no lettering is indicated on a surface of the letter storing envelope, the addressee cannot be identified even if the envelope is seen, and this is an advantage in terms of personal information management.

Additionally, an IC chip is not always required to be used, and, for example, bar codes such as an IC tag, EAN code and JAN code are applicable.

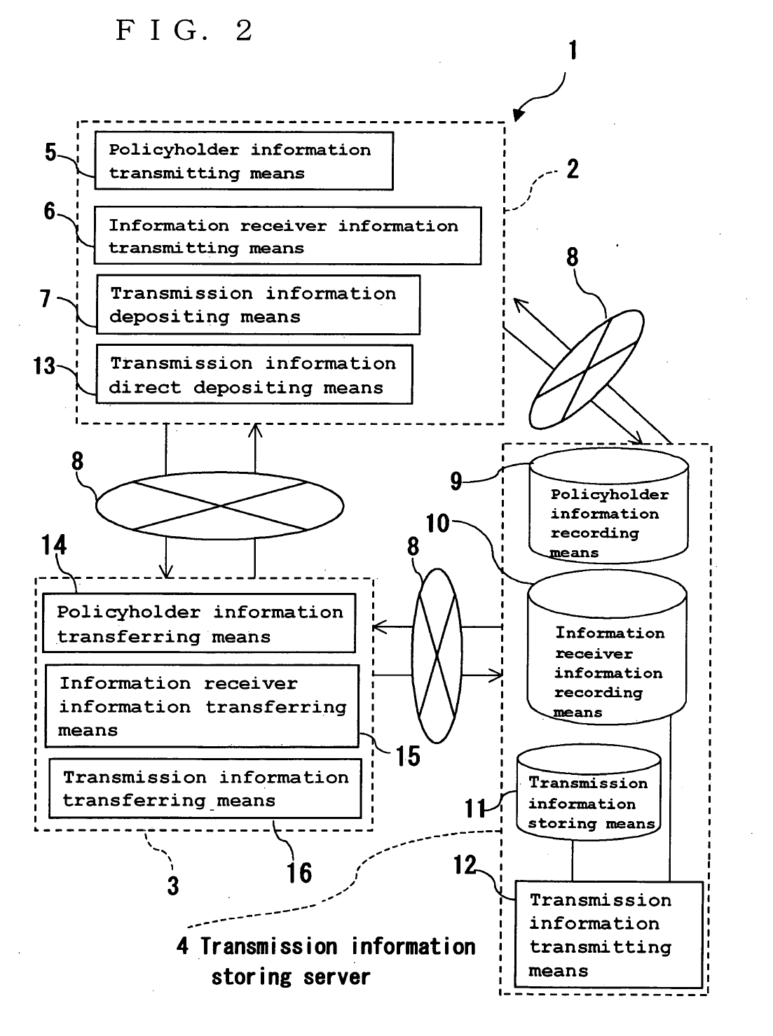

FIG. 2 is a schematic diagram illustrating an information transmission system of a second embodiment of the present invention. In FIG. 2, the information transmission system 1 of the present invention is composed of the policyholder terminal 2 used by a policyholder, the insurer server 3 used by an insurer and a transmission information storing server 4 used by a transmission information managing company.

Additionally, the policyholder terminal 2 includes: the policyholder information transmitting means 5 for transmitting the information regarding the policyholder to the insurer server 3 via the Internet 8; the information receiver information transmitting means 6 for transmitting the information regarding the information receiver, which receives information transmitted from the policyholder in the case where a predetermined condition is satisfied, to the insurer server 3 via the Internet 8; the transmission information depositing means 7 for depositing information to be transmitted to the information receiver with the insurer server 3 via the Internet 8; and transmission information direct depositing means 13 for direct depositing the information to be transmitted to the information receiver with the transmission information storing server 4 via the Internet 8.

Additionally, the insurer server 3 includes: policyholder information transferring means 14 for transferring the information regarding the policyholder to the transmission information storing server 4 via the Internet 8, the information being transmitted by the policyholder information transmitting means 5; information receiver information transferring means 15 for transferring the information regarding the information receiver to the transmission information storing server 4 via the Internet 8, the information being transmitted by the information receiver information transmitting means 6; and transmission information transferring means 16 for transferring the information to be transmitted to the information receiver to the transmission information storing server 4 via the Internet 8, the information being deposited by the transmission information depositing means 7.

Additionally, the transmission information storing server 4 includes: the policyholder information recording means 9 for recording the information regarding the policyholder transferred by the policyholder information transferring means 14; the information receiver information recording means 10 for recording the information regarding the information receiver transferred by the information receiver information transferring means 15; the transmission information storing means 11 for storing the information to be transmitted to the information receiver, the information being transferred by the transmission information transferring means 16; and the transmission information transmitting means 12 for transmitting, in the case where a predetermined condition is satisfied, the information to be transmitted to the information receiver to the information receiver recorded in the information receiver information recording means 10, the information being stored by the transmission information storing means 11.

Additionally, the transmission information storing means 11 further stores the information to be transmitted to the information receiver, the information being directly deposited by the transmission information direct depositing means 13.

Here, although an insurance contract is cited and explained as an example of a guarantee contact, a mutual-aid contract is, of course, applicable so long as it belongs to the guarantee contract.

As described above, the information transmission system of the present invention can transmit the information to be transmitted to the information receiver stored by the transmission information storing means to a desired information receiver recorded by the information receiver information recording means, at a desired timing by the transmission information transmitting means for transmitting the information in the case where the predetermined condition is satisfied, and can communicate the wishes of the policyholder to persons related to the policyholder as a message.

Additionally, the insurer server used by the insurer and the transmission information storing server used by the transmission information managing company are provided, the information regarding the policyholder, information regarding the information receiver and transmission information are recorded and stored in the transmission information storing server, and thus many employees of the insurer can be prevented from accessing and extracting personal information of the policyholder depositing the transmission information, and extraction of the information can be prevented due to an employee's mental distance as a company other than the insurer manages the information.

Additionally, the policyholder terminal includes transmission information direct depositing means for direct depositing the information to be transmitted to the information receiver with the transmission information storing server, the transmission information storing means further stores the information to be transmitted to the information receiver, the information being directly deposited by the transmission information direct depositing means, the transmission information storing server can store the transmission information without passing through an insurer, and thus a possibility is further lowered that the personal information is extracted.

1. An information transmission system for transmitting information between a policyholder terminal used by a policyholder and an insurer server used by an insurer,
wherein the policyholder terminal comprises:
policyholder information transmitting means for transmitting information regarding the policyholder to the insurer server;
information receiver information transmitting means for transmitting information regarding an information receiver, which receives information transmitted from the policyholder in the case where a predetermined condition is satisfied, to the insurer server; and
transmission information depositing means for depositing information to be transmitted to the information receiver with the insurer server, and
the insurer server comprises:
policyholder information recording means for recording the information regarding the policyholder transmitted by the policyholder information transmitting means;
information receiver information recording means for the information regarding the information receiver transmitted by the information receiver information transmitting means;
transmission information storing means for storing the information to be transmitted to the information receiver, the information being deposited by the transmission information depositing means; and
transmission information transmitting means for transmitting, in the case where a predetermined condition is satisfied, the information to be transmitted to the information receiver to the information receiver recorded in the information receiver information recording means, the information being stored by the transmission information storing means.

2. An information transmission system for transmitting information among a policyholder terminal used by a policyholder, an insurer server used by an insurer and a transmission information storing server used by a transmission information managing company,
wherein the policyholder terminal comprises:
policyholder information transmitting means for transmitting information regarding the policyholder to the insurer server;
information receiver information transmitting means for transmitting information regarding an information receiver, which receives information transmitted from the policyholder in the case where a predetermined condition is satisfied, to the insurer server; and
transmission information depositing means for depositing information to be transmitted to the information receiver with the insurer server,
the insurer server comprises:
policyholder information transferring means for transferring the information regarding the policyholder to the transmission information storing server, the information being transmitted by the policyholder information transmitting means;
information receiver information transferring means for transferring the information regarding the information receiver to the transmission information storing server, the information being transmitted by the information receiver information transmitting means; and
transmission information transferring means for transferring the information to be transmitted to the information receiver to the transmission information storing server, the information being deposited by the transmission information depositing means, and
the transmission information storing server comprises:
policyholder information recording means for recording the information regarding the policyholder transferred by the policyholder information transferring means;
information receiver information recording means for recording the information regarding the information receiver transferred by the information receiver information transferring means;
transmission information storing means for storing the information to be transmitted to the information receiver, the information being transferred by the transmission information transferring means; and
transmission information transmitting means for transmitting, in the case where a predetermined condition is satisfied, the information to be transmitted to the information receiver to the information receiver recorded in the information receiver information recording means, the information being stored by the transmission information storing means.

3. The information transmission system according to claim 2,
wherein the policyholder terminal comprises transmission information direct depositing means for direct depositing the information transmitted to the information receiver with the transmission information storing server, and
the transmission information storing means further stores the information to be transmitted to the information receiver, the information being directly deposited by the transmission information direct depositing means.

4. An information transmission system which has an insurer server used by an insurer and transmits information, wherein the insurer server comprises:
policyholder information receiving means for receiving information regarding a policyholder from a policyholder terminal used by the policyholder;
information receiver information receiving means for receiving information regarding an information receiver, which receives information transmitted from the policyholder in the case where a predetermined condition is satisfied, from the policyholder terminal;
transmission information accepting means for accepting information to be transmitted to the information receiver from the policyholder terminal;
policyholder information recording means for recording the information regarding the policyholder received by the policyholder information receiving means;
information receiver information recording means for recording the information regarding the information receiver received by the information receiver information receiving means;
transmission information storing means for storing the information to be transmitted to the information receiver, the information being accepted by the transmission information accepting means; and
transmission information transmitting means for transmitting, in the case where a predetermined condition is satisfied, the information to be transmitted to the information receiver to the information receiver recorded in the information receiver information recording means, the information being stored by the transmission information storing means.

5. An information transmission system which has an insurer server used by an insurer and a transmission information storing server used by a transmission information managing company, and transmits information,
wherein the insurer server comprises:
policyholder information receiving means for receiving information regarding a policyholder from a policyholder terminal used by the policyholder;
information receiver information receiving means for receiving information regarding an information receiver, which receives information transmitted from the policyholder in the case where a predetermined condition is satisfied, from the policyholder terminal;
transmission information accepting means for accepting information to be transmitted to the information receiver from the policyholder terminal;
policyholder information transferring means for transferring the information regarding the policyholder to the transmission information storing server, the information being received by the policyholder information receiving means;
information receiver information transferring means for transferring the information regarding the information receiver to the transmission information storing server, the information being received by the information receiver information receiving means; and
transmission information transferring means for transferring the information to be transmitted to the information receiver to the transmission information storing server, the information being accepted by the transmission information accepting means, and
the transmission information storing server comprises:
policyholder information recording means for recording the information regarding the policyholder transferred by the policyholder information transferring means;
information receiver information recording means for recording the information regarding the information receiver transferred by the information receiver information transferring means;
transmission information storing means for storing the information to be transmitted to the information receiver, the information being transferred by the transmission information transferring means; and
transmission information transmitting means for transmitting, in the case where a predetermined condition is satisfied, the information to be transmitted to the information receiver to the information receiver recorded in the information receiver information recording means, the information being stored by the transmission information storing means.

6. The information transmission system according to claim 5,
wherein the transmission information storing server comprises transmission information direct accepting means for directly accepting the information to be transmitted to the information receiver from the policyholder terminal, and
the transmission information storing means further stores the information to be transmitted to the information receiver, the information being directly accepted by the transmission information direct accepting means.
